(19) United States
(12) Patent Application Publication
(10) Pub. No.: US 2008/0081596 A1
(43) Pub. Date: Apr. 3, 2008

(54) Information processing apparatus, wireless networking adapter and e-mail notification method

(75) Inventor: Takeshi Tajima, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/898,995

(22) Filed: Sep. 18, 2007

(30) Foreign Application Priority Data
Sep. 29, 2006 (JP) 2006-269520

(51) Int. Cl. H04Q 7/22

(52) U.S. Cl. 455/412.2

(57) ABSTRACT

According to one embodiment, an information processing apparatus includes a display device, a wireless networking adapter including a function of making an inquiry whether an e-mail transmitted to a predetermined address is newly received to a mail server, and a notification unit configured to notify a newly received e-mail via the display device when the wireless networking adapter detects a newly received e-mail.

### CROSS-REFERENCE TO RELATED APPLICATIONS

This application is based upon and claims the benefit of priority from Japanese Patent Application No. 2006-269520, filed Sep. 29, 2006, the entire contents of which are incorporated herein by reference.

### BACKGROUND

1. Field

One embodiment of the invention relates to a user interface technique of giving notification of a newly received e-mail applied to an information processing apparatus such as a personal computer.

2. Description of the Related Art

With the popularization of the Internet, electronic mail (e-mail) has become widely used. An e-mail may have various files attached, and so is now indispensable as a main means of information exchange for business. With the foregoing important reason in mind, there have been made various proposals to properly acquire e-mail destined for a private address from a mail server (e.g., see Jpn. Pat. Appln. KOKAI Publication No. 2000-324543).

The e-mail transfer is made using a personal computer. In this case, the transfer is executed by an e-mail application running under an operating system (OS). In other words, an OS-established network connection is a prerequisite, and all procedures relevant to the e-mail are executed under such an operating environment.

Recently, many users make use of anti-virus software and update software. When a network connection is established by the operating system, the aforementioned software automatically starts communication via the Internet. In this way, the e-mail destined for a private address is received via the e-mail application over the OS-established network connection. In this case, the network is not limited to e-mail transfer only. As a result, the response time is slower than necessary, and (if the network is a measured rate system service), wasteful packets are transferred, increasing the cost.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the appearance of an information processing apparatus according to one embodiment of the invention;

FIG. 2 is an exemplary block diagram showing the hardware configuration of the information processing apparatus according to the embodiment;

FIG. 3 is an exemplary view showing a display produced by an e-mail notification utility program operating on the information processing apparatus according to the embodiment; and

FIG. 4 is an exemplary flowchart of the e-mail notification procedure executed by the information processing apparatus according to the embodiment.

### DETAILED DESCRIPTION

Various embodiments according to the invention will be described hereinafter with reference to the accompanying drawings. In general, according to one embodiment of the invention, an information processing apparatus includes a display device, a wireless networking adapter including a function of making an inquiry whether an e-mail transmitted to a predetermined address is newly received to a mail server, and a notification unit configured to notify a newly received e-mail via the display device when the wireless networking adapter detects a newly received e-mail.

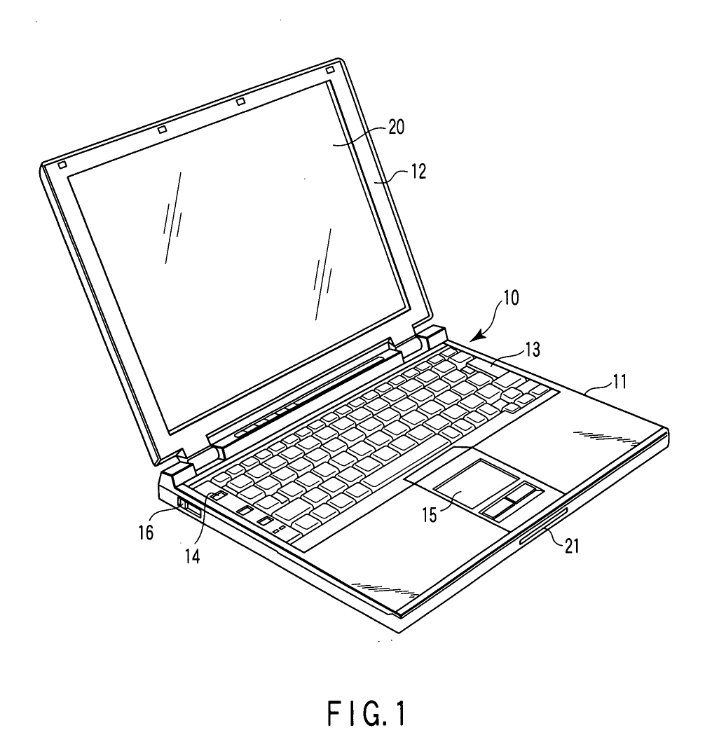

FIG. 1 is an exemplary perspective view showing the appearance of an information processing apparatus according to one embodiment of the invention. The information processing apparatus is realized as a battery-powered portable notebook personal computer 10.

The computer 10 is composed of a computer body 11 and a display unit 12. The display unit 12 has a built-in display device comprising a liquid crystal display (LCD) 20. A display screen of the LCD 20 is positioned in the center of the display unit 12.

The display unit 12 is supported on the computer body 11. The display unit 12 is further attached so that it is freely rotatable relative to the computer body 11 between an open position and a closed position. The open position is a position where an upper surface of the computer body 11 is exposed. Conversely, the closed position is a position where the upper surface of the computer body 11 is covered. The computer body 11 has a thin box-shaped case. The upper surface of the computer 11 is provided with a keyboard 13, a power button 14 and a touch pad 15. The power button 14 sets power on/off of the computer body 11.

The computer body 11 has a built-in wireless communication device. The left side of the computer body 11 is provided with a wireless communication switch 16. The wireless communication switch 16 is an operation switch for enabling or disabling wireless communication. The wireless communication switch 16 is operated, and thereby, wireless communication is disabled in a place, for example, a hospital, limiting the use of a radio signals.

The front side of the computer body 11 is provided with a sub-display 21. The sub-display 21 is provided to notify the user that an e-mail has been newly received even if the display unit is closed.

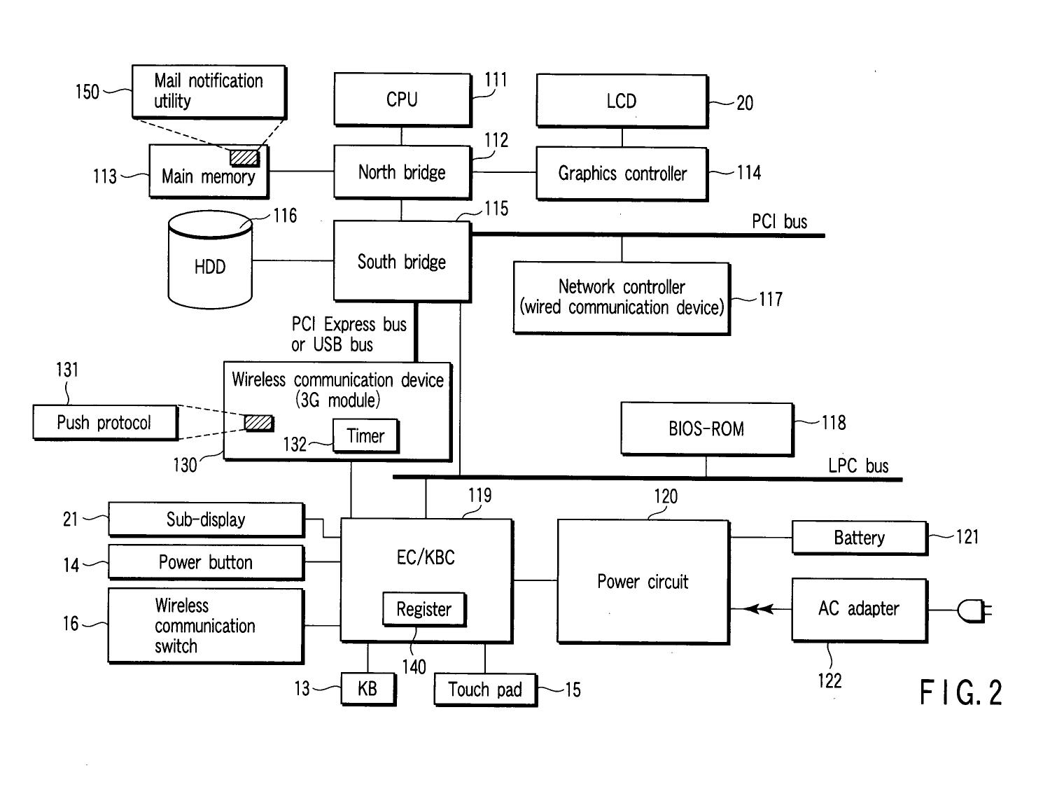

FIG. 2 is an exemplary block diagram showing the hardware configuration of the computer 10.

As shown in FIG. 2, the computer 1 includes a CPU 111, a north bridge 112, a main memory 113, a graphic controller 114, a south bridge 115, a hard disk drive (HDD) 116 and a network controller 117. The computer 10 further includes a basic input output system (BIOS)-ROM 118, an embedded controller/keyboard controller IC (EC/KBC) 119, a power circuit 120 and a wireless communication device 130.

The CPU 111 is a main processor controlling operation of the computer 10. The CPU 111 executes an operating system and various application and utility programs such as an e-mail application, loaded in the main memory from the HDD 116. An e-mail notification utility program 150 described later exists as one of the utility programs. Moreover, the CPU 111 executes a BIOS stored in the BIOS-ROM 118. The BIOS is a program used for hardware control.

The north bridge 112 is a bridge device for making a connection between a local bus of the CPU 111 and the south bridge 115. Moreover, the north bridge 112 has a function of making communications with the graphics controller via an accelerated graphics port (AGP) bus. In addition, the north bridge 112 has a built-in memory controller for controlling the main memory 113.

The graphics controller 114 is a display controller for controlling the LCD 20 used as a display monitor of the computer 10. The south bridge 115 is connected to a peripheral component interconnect (PCI) bus and a low pin count (LPC) bus. Moreover, the south bridge has a built-in IDE controller for controlling the HDD 116.

The network controller 117 is a communication device for making communication with an external device via a wired local area network (LAN).

The EC/KBC 119 is a one-chip microcomputer integrated with an embedded controller for power management and a keyboard controller for controlling the keyboard (KB) 13 and the touch pad 15. The EC/KBC 119 turns the power on/off in accordance with the power button operated by the user in corporation with the power circuit 120. The EC/KBC further has a register 140 for holding various items of setting information.

The power circuit 120 generates operating power to be supplied to each component of the computer 10 using power of the battery 121 and external power supplied via the AC adapter 122. Even if the computer 10 is off, the EC/KBC 119 and the wireless communication device 130 is supplied with operating power from the power circuit 120.

The wireless communication device 130 is a wireless networking adapter for making wireless communication with a base station according to wireless communication standards such as a wireless wide area network (WAN). The wireless communication device 130 is connected to the south bridge 115 via a PCI express bus or a USB bus. A 3G wireless WAN is a wide area network such as a cellular phone network. The wireless communication device 130 has a built-in Push protocol (mail protocol) 131 such as AirSync and DeltaMail. According to the Push protocol, the device 130 makes an inquiry as to whether or not an e-mail transmitted to a predetermined address has been received by a mail server. In addition, the wireless communication device 130 has a timer 132 independently counting date and time.

In the computer 10, the wireless networking adapter, that is, the wireless communication device 130, has a function of making an inquiry as to whether or not an e-mail transmitted to a predetermined address has been received by a mail server. By doing so, the following advantages are obtained. Namely, a check is made of whether or not an e-mail has been newly received without depending on the e-mail application, that is, involving an OS-established network connection, and then, it is properly notified to the user.

An e-mail notification utility program 150 has a user interface for inputting a mail address owned by the user of the computer 10 and an IP address of a mail server. Information acquired by the user interface is stored in the wireless communication device 130.

The wireless communication device 130 possessing the information makes the following inquiry to the EC/KBC 119 every time the timer 132 counts 30 minutes. Specifically, it is an inquiry as to whether or not the wireless communication switch 16 is in a state of enabling wireless communication. If wireless communication is enabled, the device 130 makes an inquiry to a mail server using the Push protocol 131. The response from the mail server includes the number of newly received e-mails and (if newly received e-mail exists) header information of each newly received e-mail. If newly received e-mail exists, the wireless communication device 130 sends an interrupt signal to the CPU 111. By the interrupt, the newly received e-mail is transmitted to the e-mail notification utility program 150. If the wireless communication switch 16 is in a state that disables wireless communication, the wireless communication device 130 withholds execution of the inquiry.

Information that an e-mail has been newly received is transmitted to the mail notification utility program 150. The e-mail notification utility program 150 acquires the information from the wireless communication device 130, and then, executes a display for notifying the user of the newly received e-mail on the LCD 20.

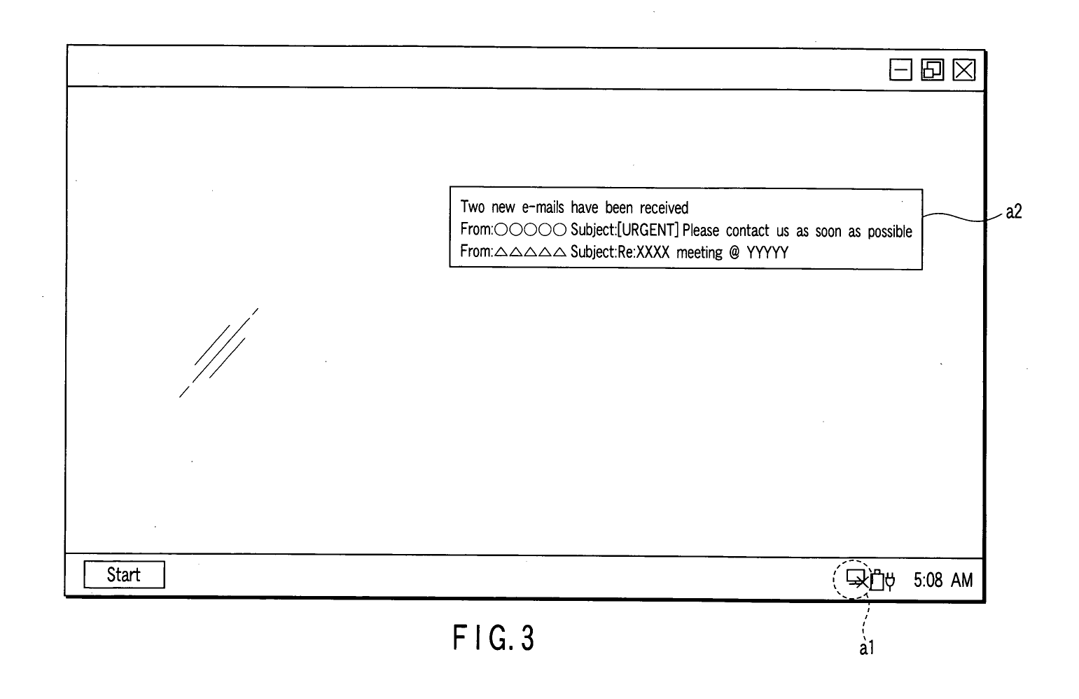

FIG. 3 is an exemplary view showing a state of a display screen of the LCD 20 when the display by the e-mail notification utility program 150 is made. An object a1 at the lower right portion of the display screen shows a state that a network connection by the operating system has not been established. Even if this state is given, the computer 10 properly displays the number of newly received e-mails, a sender of each newly received e-mail and a subject (object a2).

The user sees the foregoing display, and thereby, knows that e-mail has been newly received. At that time, the user downloads the newly received e-mail with an e-mail application. In this case, a network connection is established by the operating system, and the newly received e-mail is downloaded from the mail server with the e-mail application. Thereafter, the newly received e-mail appears in a mail box held on the HDD 116.

Specifically, when checking of newly received e-mail is periodically done, the wireless communication device 130 having the built-in Push protocol 131 communicates with a mail server. In this case, communication with a mail server is made without depending on an e-mail application (establishing a network connection by the operating system). Thus, there is no need for anti-virus or update services to be executing.

If newly received e-mail exists, the wireless communication device 130 notifies the user using the sub-display 21 via the EC/KBC 119. As described above, the EC/KBC 119 and the wireless communication device 130 are supplied with operating power from the power circuit 120 even if the computer 10 is off. Therefore, checking for newly received e-mail is done periodically (so long as communication has been enabled using the wireless communication switch 16). In other words, even if the display unit 12 is closed or the computer is off, the user is notified of newly received e-mail via the sub-display 21.

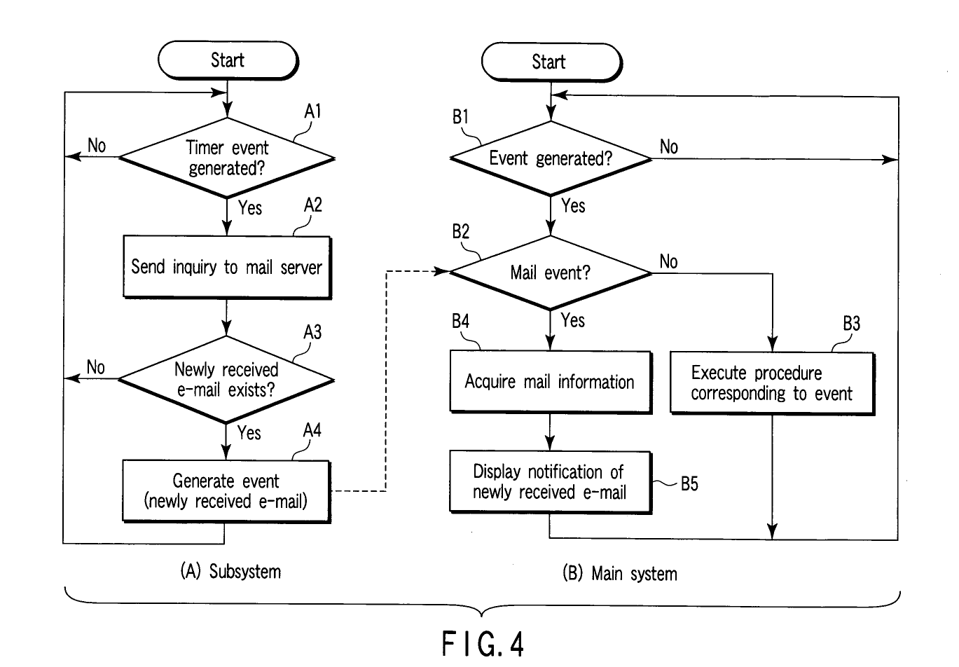

FIG. 4 is an exemplary flowchart to explain an e-mail notification procedure executed by the computer 10. In FIG. 4, a cooperative operation (independent from the CPU 111) of the EC/KBC 119 with the wireless communication device 130 is give as the flow of a subsystem. An operation under the control of the CPU 111 is given as the flow of a main system.

If a timer event is generated (YES in block A1), the wireless communication device 130 makes an inquiry whether an e-mail is newly received to a mail server (block A2). When the wireless communication device 130 receives a response such that a newly received e-mail exists with respect to the foregoing inquiry (YES in block A3), the device 130 supplies an interrupt signal the CPU 111 (block A4).

If any events generates (YES in block B1), the CPU 111 investigate whether the generated event results from what event (block B2). If the generated event does not result from a newly received e-mail (NO in block B2), the CPU 111 executes the procedure corresponding to the factor. If the generated event result from a newly received e-mail (YES in block B2), the CPU 111 transfers the control to the mail notification utility program 150. Thereafter, the mail notification utility program 150 acquires information on a newly received e-mail from the wireless communication device 130 (block B4). Then, the mail notification utility program 150 makes a display for notifying that an e-mail is newly received to user on the LCD (block B5).

In this way, the computer 10 checks whether an e-mail is newly received without making a network connection by the operating system, and properly notifies it to user.

According to the foregoing embodiment, the wireless communication device 130 has a built-in Push protocol 131, and makes an inquiry whether an e-mail is newly received to a mail server using the Push protocol. The present invention is not limited to the foregoing embodiment. An inquiry whether an e-mail is newly received is possible using poling of already existing mail protocol used for e-mail software.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display device;
a wireless networking adapter including a function of making an inquiry whether an e-mail transmitted to a predetermined address is newly received to a mail server; and
a notification unit configured to notify a newly received e-mail via the display device when the wireless networking adapter detects a newly received e-mail.

2. The information processing apparatus according to claim 1, wherein the wireless networking adapter periodically makes an inquiry to a mail server.

3. The information processing apparatus according to claim 1, wherein the wireless networking adapter makes an inquiry to a mail server using a Push protocol.

4. The information processing apparatus according to claim 1, wherein the wireless networking adapter makes an inquiry to a mail server using a poling procedure of a general protocol used for a mailer transmitting/receiving an e-mail via a computer network.

5. The information processing apparatus according to claim 1, wherein the wireless networking adapter generates an interrupt signal for executing notification via the display device by the notification unit when detecting a newly received e-mail.

6. A wireless networking adapter comprising:
an inquiry unit configured to make an inquiry whether an e-mail transmitted to a predetermined address is newly received to a mail server; and
an interrupt generation unit configured to generate an interrupt signal resulting from a newly received e-mail when the inquiry unit detects a newly received e-mail.

7. The wireless networking adapter according to claim 6, wherein the inquiry unit makes an inquiry to a mail server using a Push protocol.

8. The wireless networking adapter according to claim 6, wherein the inquiry unit makes an inquiry to a mail server using a poling procedure of a general protocol used for a mailer transmitting/receiving an e-mail via a computer network.

9. A mail notification method used for an information processing apparatus including a wireless networking adapter including a function of making an inquiry whether an e-mail transmitted to a predetermined address is newly received to a mail server, the method comprising:
periodically making an inquiry to a mail server using the wireless networking adapter; and
notifying a newly received e-mail when the wireless networking adapter detects the newly received e-mail.
